(19) United States
(12) Patent Application Publication
(10) Pub. No.: US 2018/0202012 A1
(43) Pub. Date: Jul. 19, 2018

(54) METHOD OF MAKING STEEL USING A SINGLE INSTALLATION, AND INSTALLATION

(71) Applicants: Guram KASHAKASHVILI, Tbilisi (GE); Irakli JORDANIA, Tbilisi (GE); Irakli KASHAKASHVILI, Tbilisi (GE)

(72) Inventors: Guram KASHAKASHVILI, Tbilisi (GE); Irakli JORDANIA, Tbilisi (GE); Irakli KASHAKASHVILI, Tbilisi (GE)

(21) Appl. No.: 15/550,821

(22) PCT Filed: Feb. 15, 2016
(86) PCT No.: PCT/GE2016/000001

§ 371 Date: Aug. 14, 2017

(30) Foreign Application Priority Data
Feb. 20, 2015 (GE) AP 2015 13735

(51) Int. Cl. C21C 5/52; C21C 7/00; F27B 3/18; F27D 3/12

(52) U.S. Cl. CPC C21C 5/52; F27D 3/12; F27B 3/18; C21C 7/0075

(57) ABSTRACT

The invention relates to the field of metallurgy and can be used in the making of steel in a single installation that encompasses all of the stages of the making and refining of steel as well as the casting of steel from the installation. The present installation comprises: a casting ladle with two slide gates; a water-cooled roof with electrodes, which is docked to the ladle and is connected to a gas cleaner; a slag runner; dosing bins for adding fluxes and deoxidizers; charging pipes for adding charge materials; a hot metal pouring-in funnel; a jet for injecting natural gas and air or oxygen, which is comprised of coaxial pipes and is mounted in pouring nozzle of the slide gate which is intended for melting process; and, connected to an injection apparatus, a tubule for injecting slag-forming reagents together with an inert gas or nitrogen. The installation is provided with a conveyor, which has a fuel burner and is connected to the roof. In the installation, cavities formed during melting are filled by the adding of grinded scrap and/or pre-reduced pellets, which are heated by furnace exhaust gases and/or additional natural gas flames during their motion on the conveyor covered by the roof and water-cooled. The invention makes it possible to avoid heat loss, reduce fuel consumption and also increase the stability of the process of melting and treating a metal in a single modernized installation under automated conditions without deactivating the installation and removing the furnace roof.

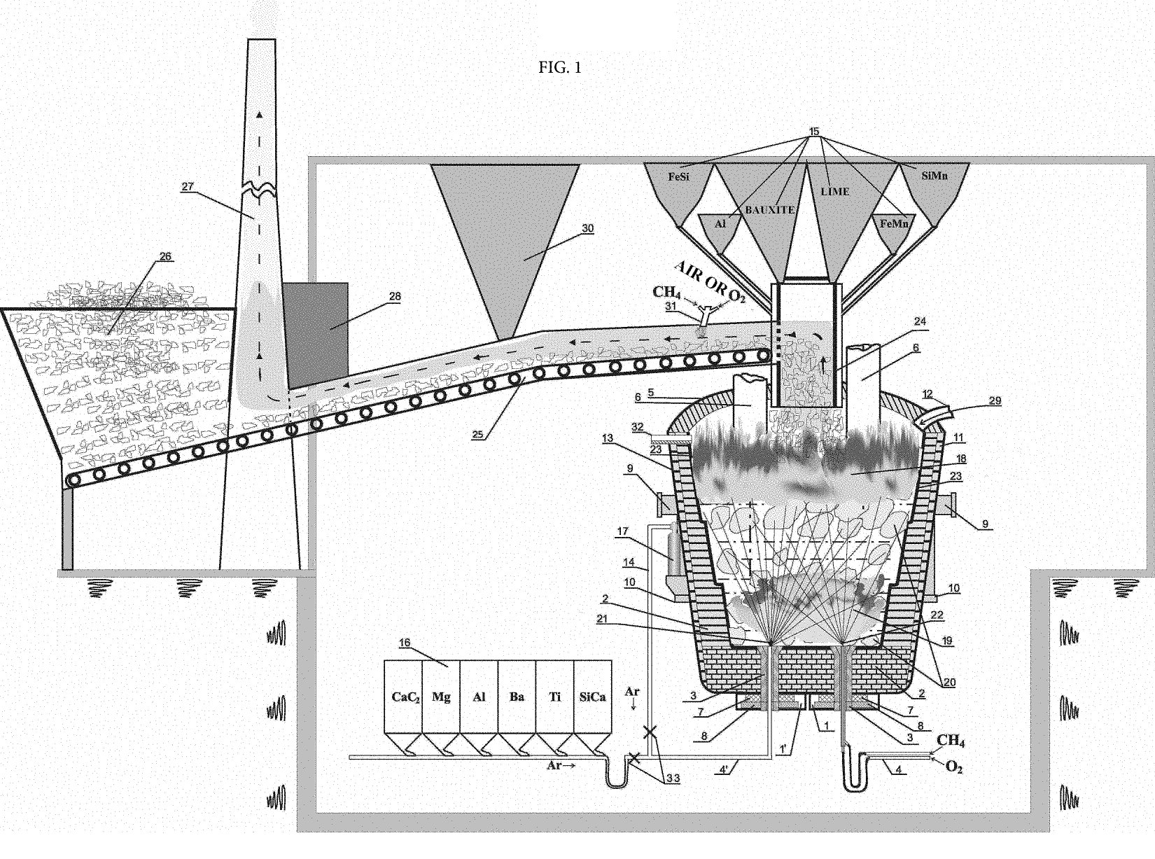

This invention belongs to the field of metallurgy and aims to replace the widespread technology of steelmaking using only the process of decarbonization in two installations (smelting and ladle furnace) with a new method of steel smelting in a single installation which by innovative technologies covers all stages of steels smelting and refining only in a single installation with solution of the world problem of steel production—optimization of carbon content in steel-smelting pool for all given steel grades as well as casting of ready steel from the casting ladle of the same installation.

Currently, over 1.6 billion tons of steel are annually smelted using the identical technology in a convertor, open-hearth, double-hearth, induction or electric arc furnaces [1].

Loading of a metal charge, melting, finishing are realized in the above mentioned main installations but steel tapping, deoxidation, secondary treatment with agents and refining are carried out in another installation—casting ladle or ladle furnace and finished steel from the same steel casting ladle is casted on continuous-casting machine or in moulds. In a high power ladle furnace together with metal heating its inert gas blowing is performed through the water-cooling nozzle from the top, and from below or a side—by usage of porous plugs.

The methods of melting, production deoxidation and treatment with inert gases have the following disadvantages:
1. In the majority of steel-smelting installations the heat is transferred from the furnace atmosphere downwards through 250-300 mm layer of the best insulating material—slag, the depth of the entire mass of metal up to the hearth, lined with bricks of good heat-conducting refractory magnesite and steel-tapping hole. Due to this, steelmakers have to overheat furnace roof using a great amount of fuel, workspace, slag, together with it—the upper layers of metal, the whole mass of the smelted steel on the magnesite hearth of furnace being in the coldest state in the area of steel-tapping hole. The mentioned fact causes overconsumption of fuel, electric power, refractory and other materials, worsens the productivity of steel-smelting installation, its operating lifetime and steel quality.
2. The traditional technologies of steel smelting compel steelmakers to overheat metal at higher than the rated temperature by 100-120° C. to compensate temperature losses during flowing of metal through the runner, casting and exposure in ladle. Along with temperature rise the overheating of metal higher than the rated temperature causes proportional growth of nonmetallic inclusions and hyperbolically—gas inclusions, especially hydrogen ones, because of which, besides of economic, worsen working conditions, qualitative and especially, ecological indices.
3. After tapping from tap-hole of furnace the metal, while flowing through the runner and contacting with atmospheric oxygen, oxidates secondarily, the amount of dissolved and nonmetal inclusions in it increases, which causes the over-expenditure of deoxidizers and alloying elements, deterioration of qualitative and environmental indices.
4. During inert gases blowing through the water-cooled nozzle from the top on the contact surface of slag and metal occurs reaction spattering of metal, the process with the use of porous plug is calm but addition of slag-forming reagents in both cases is excluded and because of this the blowing is ineffective and at blowing from the top, losses are big because of sputtering of metal. At the same time, the water-cooled jet is a great danger from the point of view of safety engineering.
5. In electric furnaces after burden slip for the purpose of filling volumes of cavities, there takes place a power outage, removing of roof, additional charging of scrap with a bucket which causes big thermal losses, idle of main installations, deterioration of furnace capacity, working conditions, economic, qualitative and ecological indices.
6. Construction of the main steelmaking installation is rather expensive, its manufacturing, assembling, lining with expensive refractory materials, technological maintenance and exploitation are associated with heavy manual labor and costs. As to the fuel and power consumption, it is so high that steel production consumes a large part of fuel and power.

There is also known the method of steel smelting, deoxidation, alloying and refining and the device for its realization which envisages charging into the ladle furnace burden composed of metal scrap and fluxes, simultaneous melting of the burden from the top by electric arc and by a powerful torch of natural gas and air or oxygen from below injected from a nozzle comprising coaxial pipes, dusted with quartz powder in the hole of the ladle slide gate, additional charging of scrap in the process of smelting, disconnection of roof from the casting ladle, its inclination and raking off the primary slag, return of the ladle to its initial position, docking of roof to the casting ladle, secondary slag formation with materials deposited from hoppers, finishing and steel rimming process, after its completion overlapping of the first slide gate, cessation of natural gas supply and air or oxygen, raking off the secondary slag, transmission of extensive treatment process by inert gases to the intensive blowing together with reagents injection in process of steelmaking, during which desulfurization and dephosphorization of steel, homogenization and optimization of temperature and chemical composition of the metal take place [2].

The main drawback of the known method of steelmaking consists in the following:
1. After burden slip, furnace at least twice is disconnected from the roof and scrap is charged by buckets until the full tonnage of the ladle is used;
2. In both process of scrap charging the molten metal is cooled, during loading the scrap is covered with a metal crust and the material becomes infusible which causes high energy costs;
3. Charging of solid scrap with buckets into the molten metal in the ladle furnace with removed roof causes intensive reactions and is a dangerous procedure in terms of safety engineering;
4. Turning off the furnace twice, cessation of the smelting process, the removal of the roof, besides of big heat losses worsen working conditions and environmental pollution indices;
5. During melting, the temperature of exhaust products of combustion to heat the charging scrap is not used.

The invention aims loading of scrap into the melting installation without removing the roof and cessation of the smelting process, using of heat emitted during the smelting of high-temperature exhausts for heating the materials dumped by charging pipes from hoppers into the furnace and supplied there scrap by the conveyor, reduction of fuel consumption, improvement of melting processes, finishing, steel deoxidation, refining with inert gases, reagents, improvement of deoxidation processes by heating the metal in a single modernized installation only up to the optimal temperature and with an abrupt improvement of its quality, also elimination of hard manual labor of the closing and opening of tap-hole of the main installation, secondary oxidation (at tapping from the furnace during flowing through the runner and filling of the ladle), processes polluting the environment, pouring of steel from the same installation on the continuous-casting machine with abrupt improvement of economic, qualitative and ecological indices.

The target was realized without shutting off the furnace and removal of its roof by supplying exhaust gases warmed with heat of steel scrap and pre-reduced pellets via the conveyor with the roof and burden receiving water-cooled charging pipe passing in the water-cooled roof of the ladle furnace receiving, by supplying of burned lime, bauxite, fluorspar and deoxidizers by charging pipes from corresponding hoppers.

The process of steel smelting covers transportation and docking with the roof of charged with scrap, pre-reduced pellets, fluxes of casting ladle with two elastic springs slide gates. One slide gate is used only for conduction of melting and finishing periods and another one—for injection of inert gas (e.g. argon) or nitrogen and reagents together with them for normal conduction of refining processes and metal casting.

The method of invention envisages gunning (coating with a layer of the refractory material) of the lining hot surface of the casting ladle, transportation of the casting ladle with two slide gates filled with steel burden to the installation of secondary treatment, docking of the ladle to water-cooled roof with electrodes (which is attached to gas cleaner by a special conveyer with the roof), melting of steel charge simultaneously from the top by electric arc and from below—with the warmth of a powerful torch formed during combustion of natural gas injected together with air or oxygen through dusted (by quartzite powder in pouring nozzle of the first slide gate) special jet consisted of coaxial pipes on the outside pipe of which natural gas is introduced and by inner pipe—air or oxygen.

Filling of the cavities in the melting process at metal shrinkage without removal of the roof is carried out by additives from hoppers with charging pipes or/and exhaust gases from the furnace ladle heated at moving on the conveyor covered with roof by exhausted from the ladle furnace gases and/or additional gas torches of shredded scrap and/or pre-reduced pellets and/or pouring of liquid iron through the special runner lined with refractory materials.

The process is carried out in an automated mode without switching off the installation, without loss of heat, without splashing of metal at loading cold scrap and other undesirable processes hindering the smooth implementation of the melting. Downloading of the primary slag without disjunction of the ladle with roof is performed by slag skimming machine through the special runner mounted on a ladle lined with refractory materials. After downloading of the primary slag under induced (by lime, bauxite and other fluxes, entered by mounted over the furnace roof dosing bins) secondary slag the periods of melting, finishing, boiling take place. If after total meltdown of burden the carbon content is higher than nominal for the ordered steel grade, then with account of the regularities of scientific discoveries 390 and 416 in 2010-2011 [3, 4], the amount of injection air or oxygen i.e. the excess oxygen coefficient is increased and decarbonization process (carbon burning from the molten steelmaking bath) is accelerated. If the carbon content in molten bath is low, i.e. small for the ordered steel grade, then natural gas consumption is increased, i.e. excess oxygen coefficient is decreased and together with decarbonization, carburization of steelmaking bath with the preservation of a strong metal boiling occurs.

With the help of a permanently operating device in the boiling process there are determined: level of liquid steel in the ladle, its temperature and content of chemical elements. After achievement of desired chemical composition and temperature the slide gate designated for melting process is closed, with it the supply of natural gas and oxygen or air is stopped. This completes the melting period. Simultaneously with this, an extensive purging of the metal with inert gas or nitrogen from the tubule, dusted by dry quartzite powder in the casting nozzle of the second slide gate, is transferred to an intensive mode, together with treatment of steel by reagents, deoxidation and alloying. The process is realized with supply of silicomanganese, ferromanganese, ferrosilicium, aluminum and other ferroalloys from the top with charging pipes from dosing bins located over the ladle furnace. With the help of heat flows directed from the bottom to the top (caused by bottom blowing of calcium carbide, calcium-silicon, magnesium, aluminum, barium and other active powdered reagents-microadditives from the injected apparatus via inert gas or nitrogen) the removal (by assimilation into active slag covering liquid steel) of deoxidation products, endogenous and exogenous nonmetallic inclusions from the finished liquid steel is accelerated.

When the steel grade requires very low index of non-metallic inclusions that is realized by low sulfur and phosphorus content, the secondary slag supersaturated with oxides, sulfides, phosphate compounds is removed and the new, third slag is formed inflowing from the upper hoppers by the slag-forming agents, active desulfurizers, reagents delivered from the bottom by injection apparatus and even after switching on the low level of the ladle furnace by emitted heat successfully continue the processes of the refining as well as deep desulfurization and dephosphorization.

After the desired chemical composition of steel is achieved, the supply of electricity in the ladle furnace is cut off and inert-gas blowing without reagents instead of pipeline is continued from argon cylinder fastened on the ladle during transportation by crane of casting ladle full with steel up to the continuous casting machine where automated process of continuous casting starts with open slide gate by cessation of the inert gas supply from the argon cylinder.

One of the examples of realization of the method with necessary devices is illustrated in FIGURE.

The installation for steel production contains slide gates (1 and 1′) located on the bottom of ladle furnace, embedded in the ladle bottom (2) and passed through the slide gates casting nozzles (3), herewith, in one of these nozzles is fixed a jet (4) for supplying natural gas and air or oxygen connected with main line and in the second—tubule (4′) to supply inert gas and reagents, and this line is connected with injection apparatus (16) for delivering of microalloying elements. A roof (5) is set on the ladle furnace in which are inserted the electrodes (6), a funnel (12) for hot metal pouring-in (29) and a water-cooled charging pipe (24) with which are connected dosing bins (15) for fluxes and deoxidizers and a conveyor (25) for burden supply. The casting ladle contains control lining (11) made on the walls in metal sheath (13) and the above-mentioned basic lining (2) which is coated with a protective refractory layer (23) obtained by pneumatic concrete gun. Also, on the outside on the sheath (13) are arranged trunnions (9), a carrier ring (10) and connected by a tubule (14) to a inert gas and reagents supplying main line (4′) a gas cylinder (17) for argon, herewith, the tubule, connected with the gas cylinder and the main line, is equipped with gate valves (33). Herewith, there is a slag runner (32) in the ladle wall and a slide gate on the bottom of the ladle contains moving (7) and stationary (8) refractory plates. The conveyor (25) covered with roof is connected to the hopper (26) for standard-size scrap, chimney (27), gas cleaner (28) and a hopper (30) for pre-reduced pellets. Besides this, for additional heating of pre-reduced pellets a burner (31) for natural gas is installed in the roof of the conveyer. The FIGURE also illustrates unfused burden (20) uploaded in the furnace, part of which is melted by electric arc (18) and gases (19). Metal flow (21) obtained by inert gas blowing and metal flow (22) obtained by natural gas blowing are also presented.

The ladle furnace is equipped with not shown in the FIGURE permanent apparatus for determining the level of liquid metal, the percentage of carbon content in it and other chemical elements.

The method of steel smelting with a single installation envisages gunning of ladle lining (2) work surface with protective layer (23) of refractory materials obtained by pneumatic concrete gun and after loading of burden materials the installation on the stand of powerful ladle furnace by casting crane, after which it is hermetically covered with water-cooled roof (5) and perform simultaneous melting of the charge from the top by electric arc (18) and from the bottom—by a powerful gas-air or gas-oxygen torch (19) blown up through coaxially located pipes (4) of jet dusted with quartzite powder in the hole of the casting nozzle of one slide gate (1). Simultaneously with start of smelting it is started and continued up to the end the blowing of inert gas or nitrogen with tubule (4′), dusted by quartzite powder in the hole of the casting nozzle of the second slide gate (1′).

Filling of the cavities formed during fusion proceeds automatically by supplying from mounted above the furnace roof a water-cooled charging pipe (24) of heated on the special conveyor (25) covered by roof and attached to a gas cleaner (28) of the chimney (27) with the use of high temperature exhaust gases during the smelting shredded scrap, grinded cutting and pre-reduced pellets.

During intensive melting of the charge (18 and 19) simultaneously with the formation of the liquid phase an extensive inert gas (e.g. argon) or nitrogen blowing of metal is carried out throughout the whole volume of the ladle. In the process of melting immediately upon slag formation, the primary slag is downloaded by skimming machine though a special slag runner (32) of the ladle and the process of steel melting, formation and boiling is continued with addition of lime and feldspar by secondary slag from the hoppers (15).

If carbon content in the pool for the smelted steel is higher than optimal then with account of the regularities of carburization-decarbonization established in the above mentioned scientific discoveries, an increase of the air consumption or oxygen is performed and with this decarbonization process (carbon burning) is accelerated.

However, if carbon content in the melted bath is low, i.e., small for the ordered steel grade then natural gas consumption is increased after which along with decarbonization rhythmic carburization of metal pool under conditions of strong pure boiling takes place.

During fusion of the steel-melting pool after reaching the optimal chemical composition of the steel, gas-air or gas-oxygen blowing, melting process and formation is ceased by closing of the first slide gate. At this point the process of refining the steel starts for which an extensive blowing with inert gas or nitrogen is transmitted to the intensive mode and combined with the process deoxidation-alloying which is realized by supplying alloys from dosing bins (15) and by blowing of slag forming reagents into metal and microalloying from the injection apparatus (16) by means of inert gas there is realized steel deoxidation, compatibility of alloying processes, refining with inert gases and reagents and assimilation in slag deoxidation products, endogenous, exogenous, including gas inclusions.

If smelted steel grade is special superduty—special critical duty, and requires inclusion index approximated to the level of steel vacuum treatment—low sulfur and phosphorus content, then the slag saturated with different oxides is downloaded. After this, through addition of lime and fluorspar from the upper hoppers and blowing in strong reagents from the bottom from the injection apparatus the formation of a new slag occurs; it is heated together with metal by using the heat the warmth of electric arc and through simultaneous blowing of an inert gas (e.g. argon) or nitrogen perform deep desulfurization and dephosphorization caused by blowing process with heat flows, remove from steel sulfide, Sulfide and phosphide nonmetallic inclusions, including gas nonmetallic inclusions as much as possible, especially hydrogen (to a minimal content).

After obtaining the ordered steel grade the blowing of argon into the ladle is continued from the balloon (17) instead of stationary main line during transportation of the ladle by pouring crane up to the continuous casting machine where automation process of continuous casting from the casting ladle (a single installation of casting-refining—ladle furnace) in intermediate ladle and then into crystallizers begins with an open slide gate together with overlapping of argon supply from the balloon.

In order to increase the longevity of the ladle working lining, the restoration of the protective layer of the protective refractory layer with pneumatic concrete gun is carried out after each pouring.

Positive effect of the presented innovation consists in:
1. Melting, formation, deoxidation and treatment with inert gases and reagents is carried out only in the ladle furnace instead of traditional two installations where till now almost all melts are overheated at 100-120° C. for compensation of the expected temperature losses during steel making from the furnace, soaking in the ladle and pouring. In the single installation—ladle furnace proposed by us the smelting-refining is carried out without overheating only by heating up to the optimal temperature (1530-1540° C.) with elimination of heavy manual labor of opening-closing of the steelmaking hole of the main installation, forced overheating of metal at 100-120° C., its secondary oxidation environment contamination when tapping from the furnace and flowing on the runner.
2. After installation of the ladle filled with scrap and feedstock materials on the stand of the ladle furnace, the filling of the cavities formed at simultaneous melting by electric arc and heat flux from a powerful jet from the bottom occurs by input from a special conveyor covered with roof and/or charging pipes heated by exhaust from the ladle furnace gases iron and/or grinded fillings and/or pre-reduced pellets, to reduce fuel and energy consumption. If necessary, an additional scrap preheating to the optimum temperature is possible with natural gas the blowing of which is carried out with one or several burners (31) mounted in the container roof. The above mentioned technological operations are carried out without cessation of natural gas supply, removing of the roof of the ladle furnace during the next charging, without losses of metal temperature and heat, big industrial losses and also without extreme deterioration of the difficult working conditions, ecological indices and overloading of the main equipment (melting installation and smelting cranes) and gross violation of safety.
3. The proposed new method of steel melting and installation gives huge energy savings, fuel, costly refractory bricks, ferroalloy and other materials needed for steel production time.
4. Abolished The forced overheating of metal on 100-120° C., opening and closing of the tap-holes and necessary for this steelmakers' hard physical labor and what is important, immense pollution when metal making and flowing on the runner along with the secondary oxidation. Metal is heated within the range of optimal temperatures due to which nonmetal inclusions will be less, including gas, especially hydrogen, the solubility of which in the steel is increased proportionally to its temperature and hyperbolically—after overheating of the metal over 1600° C.
5. Along with the elimination of air pollution in steelmaking main installation and its release from it much better environmental conditions will be created, since while blowing from the bottom the natural gas protects iron from oxidation, the yield of the ready metal is increased and suspension dust is melted in the metal pool of 3-4 m height before its emergence on the surface.

### INFORMATION SOURCES

1. General Metallurgy. Edited by E. V. Chelishchev. Moscow. Publishing house “Metallurgy”. 1971. pp. 342-352. in Russian.
2. Georgian patent GE P5552. http://www.sakpatenti.gov.ge/en/publications/?subject=OFFICIALBULLETINSOFINDUSTRIALPROPERTY
3. Kashakashvili G. B. et al. The regularity of the carbon content change in liquid steel from the heating temperature during its blowing by a gas-air mixture. Scientific discovery #390. 2010. In the Collected Articles of short descriptions of scientific discoveries, scientific hypotheses “Scientific discoveries”. Former Pototski V. V. Moscow. Russian Academy of Natural Sciences. 2011. pp. 20-21. in Russian.
4. Kashakashvili G. B. et al. The regularity of carburization of liquid steel pool during its deep blowing by a gas-air mixture. Scientific discovery #416. 2011. In the Information-analytical review “Scientific discoveries, ideas, hypotheses”. Former Pototski V. V. Moscow. Russian Academy of Natural Sciences. 2013. pp. 117-118. in Russian.

1. The method of making steel with a single installation which envisages charging of fluxes, scrap and/or pre-reduced pellets into casting ladle with two slide gates after gunning of its lining, docking the ladle to attached to gas-cleaner water-cooled roof with electrodes, after which the process of steel melting is carried out simultaneously from the top by electric arc and from the bottom—by the heat of the torch formed during burning of natural gas blown in with the air or oxygen through the jet composed from coaxial tubes and dusted with quartzite powder in the casting nozzle of the slide gate which is intended for melting process, through the outer tube of which natural gas is supplied and through the inner tube—air or oxygen, the cavities formed during melting are filled by pouring-in of hot metal and/or the addition from hoppers via charging pipes grinded scrap and/or pre-reduced pellets, which are heated by furnace exhaust gases and/or additional natural gas flames during their motion on the conveyor covered by the roof, and the primary slag formed in the melting process is raked off by skimming machine through the ladle slag runner, after which supply of fluxes from the dosing bins is carried out, secondary slag is formed and carbon content after fusion of burden is regulated by the ratio of compressed air or oxygen and natural gas volumes with carburization and decarbonization processes and after the achievement of the desired composition of steel, natural gas-air or gas-oxygen blowing is ceased by overlapping of the slide gate which is intended for melting, besides this, with the beginning of the melting process the injection of natural gas or nitrogen from the second casting slide gate is started and continued together with the process of deoxidation-alloying by supplying of deoxidizers and ferroalloys from the top by dosing bins and from below—by injection of inert gas or nitrogen and slag forming elements from the injection apparatus into metal by which is performed formation and/or further downloading of the slag necessary for desulphuration and dephosphoration and continuation of the refining process with active reagents and argon or nitrogen with the help of the electric arc warmth and after homogenization of chemical composition and temperature of steel in the ladle furnace voltage is disconnected and for transportation to the casting place blowing of inert gas and nitrogen is continued from the gas cylinder fastened on the ladle construction and blowing of inert gas and nitrogen is ceased immediately before the casting starts.

2. The installation for steel smelting which contains casting ladle with two slide gates and working layer recovered by gunning of refractory lining, docked to this ladle and connected to the gas-cleaner water-cooled roof with electrodes, runner for slag removal, dosing bins for adding fluxes and deoxidizers into the ladle, charging pipes for adding charge materials, a hot metal pouring-in funnel, gas-cleaner and attached to the roof conveyer equipped with the roof, and at least one heater is inserted in the roof of conveyer, the installation also contains the jet composed of coaxial tubes for injection of natural gas and air or oxygen and dusted with quartzite powder in pouring nozzle of slide gate designated for melting process, dusted with quartz powder in the pouring nozzle of the second slide gate and connected with flexible connection to injection apparatus tubule with gate valves for blowing inert gas or nitrogen together with slag forming reagents and microalloying additions, the gas cylinder fastened on metal construction of the ladle and connected with the tubule fixed in the hole of the second slide gate.
